(19) United States
(12) Patent Application Publication
(10) Pub. No.: US 2023/0115272 A1
(43) Pub. Date: Apr. 13, 2023

(54) CLASSIFIER FOR VALVE FAULT DETECTION IN A VARIABLE DISPLACEMENT INTERNAL COMBUSTION ENGINE

(71) Applicant: Tula Technology, Inc., San Jose, CA (US)

(72) Inventors: Louis J. SERRANO, Los Gatos, CA (US); Elliott A. ORTIZ-SOTO, San Jose, CA (US); Shikui Kevin CHEN, Leander, TX (US); Li-Chun CHIEN, Milpitas, CA (US); Aditya MANDAL, San Jose, CA (US)

(21) Appl. No.: 17/860,838

(22) Filed: Jul. 8, 2022

Related U.S. Application Data
(60) Provisional application No. 63/253,806, filed on Oct. 8, 2021.

(51) Int. Cl. F02D 41/22; F01L 13/00; F02D 41/00; G01M 15/11; G01M 15/05; G05B 13/02

(52) U.S. Cl. CPC F02D 41/22; F01L 13/0005; F02D 41/0087; F02D 41/009; G01M 15/11; G01M 15/05; G05B 13/027; F01L 2013/001; F02D 2200/0406; F02D 2200/101

(57) ABSTRACT

A classifier capable of predicting if cylinder valves of an engine commanded to activate or deactivate failed to activate or deactivate respectively. In various embodiments, the classifier can be binary or multi-class Logistic Regression, or a Multi-Layer Perceptron (MLP) classifier. The variable displacement engine can operate in cooperation with a variable displacement engine using cylinder deactivation (CDA) or skip fire, including dynamic skip fire and/or multi-level skip fire.

### CROSS REFERENCE TO RELATED APPLICATIONS

This application claims priority to U.S. Provisional Application No. 63/253,806 filed Oct. 8, 2021, which is incorporated by reference herein for all purposes.

### FIELD OF THE INVENTION

The present invention relates to a classifier for predicting valve faults for a variable displacement engine where some cylinder events are commanded to skip and other cylinder events are commanded to fire, and more particularly, to a classifier capable of predicting if valves commanded to activate or deactivate failed to activate or deactivate respectively.

### BACKGROUND

Most vehicles in operation today are powered by internal combustion engines (ICEs). Under normal driving conditions, the torque generated by an ICE needs to vary over a wide range to meet the demands of the driver. In situations when full torque is not needed, fuel efficiency can be substantially improved by varying the displacement of the engine. With variable displacement, the engine can generate full displacement when needed, but otherwise operates at a smaller effective displacement when full torque is not required, resulting in improved fuel efficiency.

A conventional approach for implementing variable displacement ICE is to activate only one group of one or more cylinders, while a second group of one or more cylinders is deactivated. For instance, with an eight-cylinder engine, groups of 2, 4 or 6 cylinders can be selectively deactivated, meaning the engine is operating at fractions of ¾, ½ of ¼ of full displacement of the engine respectively.

Skip fire engine control, another known approach, facilitates finer control of the effective ICE displacement than is possible with the conventional approach. For example, firing every third cylinder in a 4-cylinder engine would provide an effective displacement of ⅓^{rd} of the full engine displacement, which is a fractional displacement that is not obtainable by simply deactivating a group of cylinders. With skip fire operation, for any firing fraction that is less than one (1), there is at least one cylinder that is fired, skipped and either fired or skipped over three successive firing opportunities. In a dynamic variation of skip fire ICE control, the decision to fire or skip cylinders is typically made on either a firing opportunity-by-firing opportunity or an engine cycle-by-engine cycle basis.

Multi-level Miller-cycle Dynamic Skip Fire (mDSF) is a yet another variation of skip fire ICE control. Like DSF, a decision is made for either skipping or firing each cylinder event. But with mDSF, an additional decision is made to modulate the torque output with fired cylinder event to be either Low (Miller) or High (Power).

In conventional all-cylinder firing ICEs, measuring angular acceleration can be used to detect misfires. When all cylinders of an ICE are properly fired, they each generate approximately equal torque during their respective power strokes. When a misfire occurs, however, a misfire of a particular cylinder can be detected from a reduced angular acceleration. Another known misfire detection method relies on one or more pressure sensors located in the intake and/or exhaust manifold(s) for detecting pressures consistent with either successful fires or misfires. For conventional all-cylinder firing engines, these approaches provide a reasonably accurate means for misfire detection.

With mDSF controlled ICEs, measuring angular acceleration and/or pressure is generally inadequate for misfire detection. Since cylinders may be commanded to be skipped or generate only a Low (Miller) torque output, a measured low angular acceleration and/or pressure is not necessarily indicative of a misfire. As a result, it difficult to discern a misfire from an intentional skip and/or a low torque output when measuring only angular acceleration during the power stroke of a cylinder.

### SUMMARY OF THE INVENTION

The present invention is directed to various classifiers capable of predicting if cylinder valves of an engine commanded to activate or deactivate failed to activate or deactivate respectively. In various embodiments, the classifier can be binary or multi-class Logistic Regression, or a Multi-Layer Perceptron (MLP) classifier. The variable displacement engine can operate in cooperation with engines controlled using cylinder deactivation (CDA) or skip fire, including dynamic skip fire and/or multi-level skip fire.

### BRIEF DESCRIPTION OF THE DRAWINGS

The invention and the advantages thereof, may best be understood by reference to the following description taken in conjunction with the accompanying drawings in which:

FIG. 1 is a diagram illustrating Miller and Power intake valve behavior for High fire, Low fire and skips of a cylinder in accordance with a non-exclusive embodiment of the present invention.

FIG. 2A illustrates an exemplary classifier including a neural network with one hidden layer in accordance with a non-exclusive embodiment of the invention.

FIG. 2B illustrates either a hidden layer or output node configured to implement an activation function on a sum of weighted inputs from a previous layer in accordance with a non-exclusive embodiment of the invention.

FIG. 3 illustrates an exemplary machine learning based binary Logistic Regression classifier in accordance with a non-exclusive embodiment of the invention.

FIG. 4 illustrates an exemplary machine learning multi-class Logistic Regression classifier in accordance with a non-exclusive embodiment of the invention.

FIG. 5 illustrates an exemplary system for detecting valve faults in a mDSF controlled internal combustion engine and in accordance with a non-exclusive embodiment of the invention

In the drawings, like reference numerals are sometimes used to designate like structural elements. It should also be appreciated that the depictions in the figures are diagrammatic and not to scale.

### DETAILED DESCRIPTION

The present invention relates to a classifier for predicting valve faults for a variable displacement Internal Combustion Engine (ICE) where some cylinder events are commanded to skip and other cylinder events are commanded to fire, and more particularly, to a classifier capable of predicting if valves commanded to activate or deactivate failed to activate or deactivate respectively. Such variable displacement ICEs may include conventional cylinder deactivation (CDA) where a first group of one or more cylinders are continually fired and a second group of one or more cylinders are continually skipped, skip fire, dynamic skip fire, and multi-level Miller-cycle Dynamic skip fire (mDSF). It is noted that while the description of the various embodiments of classifiers of the present invention as provided herein are largely described in the context of a mDSF controlled ICEs, this is by no means a limitation. On the contrary, the various classifiers as described herein are also applicable to any type of variable displacement ICE, including CDA, skip fire and/or dynamic skip fire.

“mDSF” improves fuel efficiency by dynamically deciding for each cylinder-event (1) whether to skip (deactivate) or (b) fire (activate) a cylinder of an ICE; and (2) if fired, determining if the intake charge should be Low (Miller) or High (Power). With Low and High charges, the torque output generated by the cylinder is either Low or High respectively. The ability to select among multiple charge levels allows mDSF controlled ICEs to minimize the trade-off between fuel efficiency and excessive Noise, Vibration and Harshness (NVH). For more details on mDSF, see for example commonly assigned U.S. Pat. No. 9,399,964 entitled Multi-Level Skip Fire, incorporated by reference herein for all purposes.

### mDSF Operation

During operation, the torque demand placed on an ICE may widely vary from one hundred percent (100%) of the possible torque output to zero (0%). At each output level, the demanded torque can be met with a mix of skips, Low fires, and High fires as determined by an engine controller relying on one or more algorithms. For example:

(1) When the torque demand is zero (0%), the engine controller may operate the ICE in a Deceleration Cylinder Cut-Off (DCCO) mode where all the cylinders are skipped and no torque is generated;

(2) When the torque demand is one hundred percent (100%) of the torque output, the engine controller may operate the ICE to fire all cylinders with a High charge (Power) every firing opportunity. In this way, the torque demand is met; and

(3) When the torque demand ranges anywhere from one percent (1%) to ninety-nine percent (99%), the engine controller operates the ICE with a mix of skips, High fires, and/or Low fires as needed to meet the request. In various embodiments, the control algorithms relied on by the engine controller balances variables such as fuel efficiency and NVH considerations when defining various skip/High-Fire/Low-Fire patterns needed to meet a given torque demand.

### Valve Operation with mDSF

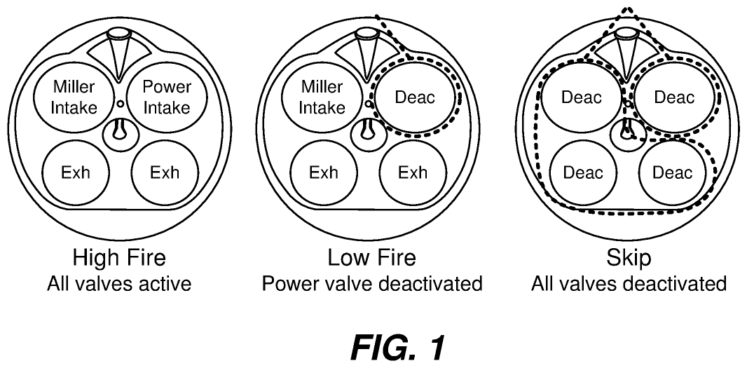

Referring to FIG. 1, a diagram illustrating an exemplary cylinder with two intake and two exhaust valves is illustrated. With mDSF, the intake and exhaust valves are selectively controlled to implement:

(a) A High-Power fire by activating both intake valves (labeled “Miller” and “Power” respectively). As a result, the cylinder inducts a full charge of air;

(b) A Low-Power fire by activating only the Miller intake valve, while deactivating the Power intake valve. As a result, the inducted air charge is modulated or lower compared to a full charge of air used for a High-Power fire; and

(c) A Skip by closing both valves. As a result, no air charge is inducted.

### Fault Modes and Detection

This ability to modulate the charge level with mDSF control introduces failure modes not applicable with other types of variable displacement ICE where cylinders are merely skipped or fired. These additional failure modes include:

A first mode that occurs when a High-Power fire is desired, but only one of the intake valves opens, while the other fails to open. As a result, there will be a high fuel charge, but the air intake charge will be lower than desired and insufficient for a High-Power combustion event;

A second mode occurs if a Low Power fire is desired, but one of the intake valves fails to deactivate (i.e., the valve opens). As a result, the fuel charge will be low, but too much air charge will be inducted for a Low Power fire.

The above-defined faults are typically more difficult to detect than a misfire in a variable displacement ICE where cylinders are either fired or skipped. With a misfire, there is generally no combustion, which is relatively easy to detect. On the other hand, with the above-described failure modes, some level of combustion is likely to occur. Therefore, the recognition of a misfire event with a mDSF controlled ICE involves determining if a combustion event was of the correct magnitude, which is a significantly more challenging than merely detecting that no combustion occurred.

With mDSF controlled ICEs, the above-described faults are problematic for several reasons. First, both types of failures prevent stoichiometric operation of the ICE, increasing noxious emissions. Second, undesirable NVH may arise from such faults. Detecting such faults is therefore desirable.

### Oil Control Valves and Fault Detection

With many ICEs, Oil Control Valves or “OCVs” are used to control the activation and deactivation for the Miller and Power intake valves and the exhaust valve(s). When valves fail to either activate or deactivate as commanded, it is often caused by a failure of the corresponding OCV. Depending on circumstances, the OCV failures can either be easy to detect or difficult to detect.

An example of a relatively easy OCV fault to detect is when the Miller intake and both exhaust valves fail to activate as commanded. If these valves all fail to open, then no gas flows through the cylinder when otherwise expected. Alternatively, if the same valves all fail to deactivate, then gas will flow through the cylinder when the absence of gas was expected. Either way, these faults are relatively easy to detect based on the presence or absence of gas flow, and whether such gas flow was expected or not.

More challenging faults to detect occur when the Power intake valve of a cylinder fails to reactivate (i.e., commanded to open) or deactivate (i.e., commanded to remain closed) while the remaining valves are active. If the Power intake valve fails to reactivate and open when a High-Fire is commanded, too little air will be inducted for the injected fuel amount. Alternatively, a failure for the Power intake valve to properly deactivate for a Low-Fire, results in too much air being inducted for the injected fuel amount. Either way, the resulting combustion event is likely to be highly variable due to a variety of factors besides a mismatch in the air-fuel ratio, such as the engine speed, torque load, firing fraction, etc. Consequently, the combustion events that occur when a Power intake valve fails to activate or deactivate may look similar or very different than a properly executed High or Low fire. Detecting such Power intake valve faults is therefore difficult.

### Inadequacies of Conventional Valve Fault Detection Methods

As noted, conventional valve fault detection methods rely on crank angle acceleration and/or measured MAP pressure. With non-variable ICEs where all cylinders are fired, these algorithms work by identifying a fault signature in MAP and/or crank angle acceleration behavior that otherwise varies very little from one cylinder event to the next. Neither of these methods, however, work well with mDSF because the modulated outputs of fired cylinders (e.g., either High or Low) cause both MAP behavior and crank angle acceleration behavior to widely vary from one cylinder event to the next. In addition, previous and succeeding cylinder events also influence MAP and crank angle acceleration behavior. With mDSF, the previous cylinder event before the current cylinder can be a skip, High fire, or Low fire. The current cylinder can have a fault or not, and the succeeding cylinder event can again be a skip, High fire, or Low fire. As a result, there are eighteen (18) possible cylinder event sequences, which further complicates and makes valve fault detection even more difficult. Conventional algorithms, therefore, have difficulty discerning a valve fault signature from the normally varying MAP and crank angle behavior that occurs with mDSF operation.

### Machine Learning

With machine learning, a neural network defining a prediction algorithm is fed training data. In response, the prediction algorithm, implemented by the neural network, learns how to make the predictions the algorithm was design to perform. As a rule, the more training data that is fed to the neural network, the more accurate the algorithm becomes at making predictions.

Once an algorithm is trained, it may be deployed to make predictions using real-world input data. For example, neural networks have proven to be adept for tasks such as image or pattern recognition. During operation, the prediction algorithm continues to “learn” using the inputs it is provided. Thus, during operation, the algorithm tunes itself to make more accurate predictions.

### Neural Network

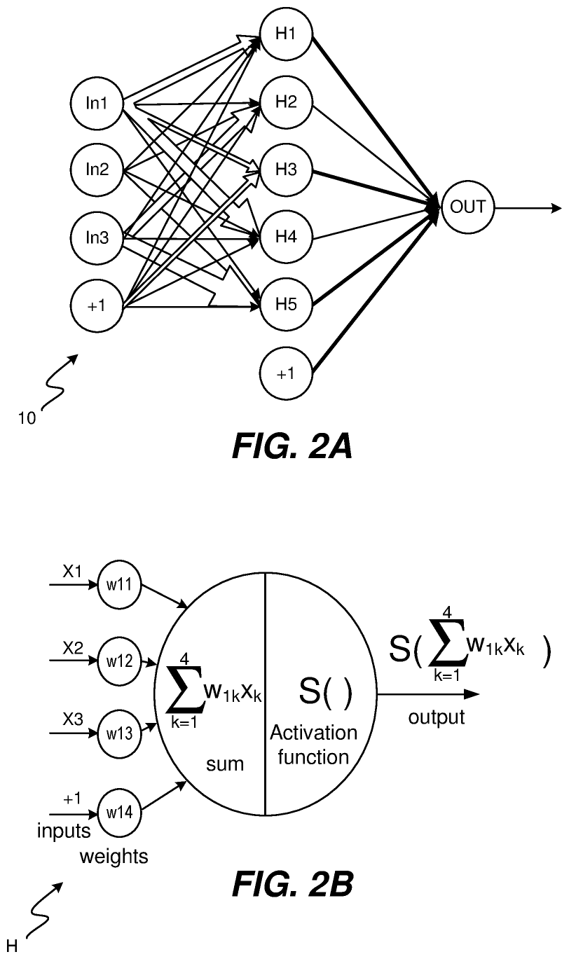

Referring to FIG. 2A, a model of an exemplary neural network 10 is illustrated. The neural network 10 includes an input layer including a plurality of input nodes (In1, In2, In3, . . . and a bias term represented by “+1”), one or more hidden layers and another bias term +1, and an output layer (Out).

For the sake of simplicity, only three inputs (In1, In2, In3) are shown. It should be noted that the number of inputs may widely vary and be either more or fewer than three.

Also, for the sake of simplicity, only one hidden layer is shown. In alternative embodiments, multiple hidden layers or no hidden layers may also be used. Regardless of the number of hidden layers, the individual nodes H in the one or more hidden layers are preferably “densely” connected, meaning each node H receives inputs from all the nodes in the previous layer. For example, with the neural network 10 as illustrated, each of the nodes H1 through H5 receives an input from each of the input nodes In1 through In3 and the bias term +1 of the input layer respectively.

In a non-exclusive embodiment, the inputs into any given node may also be weighted. In the embodiment shown in FIG. 2A, the relative weight of each input node is graphically represented by the thickness of the arrow pointing to the nodes in the next layer. For example, the In1 input to node H4 is weighted more heavily compared to the In3 input, as graphically depicted by the thick and thin arrows respectively.

Referring to FIG. 2B, an exemplary node H in one of the one or more hidden layers (or the output layer) of the neural network 10 is illustrated. In this example, the inputs to the node H are combined as a linearly weighted sum of its inputs (e.g., (In1, In2, In3) and the bias term (+1), designated in the equation below as “4”:

$${\sum }_{k = 1}^{4} {w}_{1 k} {x}_{k}$$

The weighted sum is then input to an activation function, referred to here as “S”, which is a non-linear monotonic function, often a sigmoid function or a ReLU (rectifying linear unit) function, resulting in the output:

$$S ( {\sum }_{k = 1}^{4} {w}_{1 k} {x}_{k} )$$

Due to the regularity of the neural network 10, it is relatively easy to calculate the number of operations required to calculate the output. If the layer has Nᵢ nodes, and every node at every layer is connected to every node at the prior layer (plus a bias term), each layer will have (Nᵢ₋₁+1) *Nᵢ multiply-and-accumulate (MAC) operations (plus an activation function) and the total number of MAC operations can be found by summing over the layers.

For example, a neural network with 30 inputs (plus a bias term, or 31 inputs) in the input layer, and two hidden layers of 100 nodes each followed by 1 output layer node, approximately (31×100)+(101×100)+(101×1)=13,301 multiply-and-accumulate MAC operations per detection are required. In other words, the first hidden layer of 100 nodes performs 3100 MAC operations on the 31 inputs (31×100=3100), the second hidden layer of performs 10,100 MAC operations (101×100=10,100, e.g., 100 nodes in first hidden layer and one (1) bias term or 101 inputs are provided to each of the 100 nodes of the second hidden layer), and the output node performs 101 MAC operations (100 nodes in second hidden layer plus one (1) bias term or 101 inputs to the single output node).

It is noted that the dense neural network 10, as illustrated in FIG. 2A and FIG. 2B, is sometimes referred to as a Multi-Layer Perceptron (MLP) classifier. It should be understood, however, that the present invention as described herein may use other types of neural network classifiers, such as convoluted neural network classifiers, recursive neural network classifiers, binary or multi-class logistic classifiers, etc. Regardless of the type of neural network classifier used, each will be configured to implement a machine learning algorithm. Accordingly, as used herein, the term “classifier” is intended to be broadly construed to include any type of neural network classifier, not just those explicitly listed or described herein.

### Machine Learning and Valve Fault Detection

The present application is directed to a computationally efficient machine learning model for fault detection in variable displacement ICEs, such as but not limited to a mDSF controlled ICE. As explained in detail below, a neural network classifier, such as the MPL classifier as illustrated in FIGS. 2A and 2B, or any of the other neural network classifiers mentioned herein, is first trained using input test data to identify a Power intake valve fault in a mDSF controlled ICE. Specifically, the algorithm implemented by the neural network is trained to determine Power intake valve faults when:

(1) A High fire is commanded, but a lower air charge occurs due to the Power intake valve failing to activate (i.e., fails to open); and

(2) A Low fire is commanded, but a higher air charge occurs due to the Power intake valve failing to deactivate (i.e., fails to remain closed).

Once trained, the neural network classifier is then employed on an actual mDSF controlled ICE the same or similar to that used during the training. During operation of the ICE, the trained algorithm of the neural network classifier compares the actual commands given to the Power intake valves of the cylinders of the ICE with predicted behavior of the Power intake valves based on inputs provided to the trained neural network classifier on a cylinder event-by-cylinder event basis. If the actual commanded and predicted behavior for a given cylinder event when compared are the same, it is assumed no fault occurred. On the other hand, if the comparison yields different results, then it is assumed a Power intake valve fault has occurred for the given cylinder event. In this way, the trained neural network classifier generates fault flags, as they occur, during operation of the ICE.

### Training Data

The data selected for training the classifier typically involve ICE or vehicle parameters that are relevant or indicative of the behavior of the Power intake valves. Such parameters may include, but are not limited to, the following:

(1) Crank acceleration during one or more of intake, compression, and combustion strokes of cylinder events;

(2) MAP during the intake stroke;

(3) Mass Air Flow (MAF);

(4) Intake and exhaust cam phase angles;

(5) Engine speed;

(6) Requested torque.

Again, the above-listed test data is typically collected or otherwise derived from a test ICE and/or vehicle the same or similar to a target ICE and/or vehicle in which the classifier will be employed. It is also noted that the list (1) through (6) provided herein is intended to be exemplary and should not be construed as limiting in any regard. In alternative embodiments, other parameters may be used as well.

In addition, the data used for training further includes:

(7) The actual valve commands provided to each cylinder for each cylinder event;

(8) Data indicative of the actual behavior of the valves during each cylinder events, and
(9) The fire or skip status of the previous and/or succeeding cylinder for each cylinder event respectively.

With this information, the machine learning algorithm trains the network by recognizing patterns within the data (1) through (9) that are indicative of both successful and unsuccessful skips, Hire and Low fires, or any subset thereof, respectively.

In general. the more data and the iterations of cylinder events the machine learning algorithm processes, the more accurate the training of the classifier becomes in flagging Power intake valve faults.

Since the classifier can receive only numeric inputs, the different cylinder states (e.g., Previous, Current and/or Next) are typically encoded. In a non-exclusive embodiment using two bits of information, the bit pairs, (00), (01), and (10), are encoded to signify a skip, a Low fire, and a High fire respectively. Once encoded, the information is provided to the classifier to signify the commands provided to the cylinders for each cylinder event. Similar encoding schemes may be used to provide other information to the classifier, such as codes the are descriptive of actual valve behavior during cylinder events, preceding and succeeding cylinder events, etc. It is noted that any specific encoding scheme mentioned herein is merely exemplary. Other encoding schemes may be similarly used.

Referring to Table I below, a summary of the possible inputs provided to a classifier for detecting Power intake valve faults is provided. In this example, the crank angle and MAP signals were sampled at 30° intervals, or 6 times per stroke for a 4-cylinder ICE. The term “cylinder status” is the commanded operation of the cylinder, either Skip, Low fire, or High fire. The Input Type characterizes the corresponding data input. For instance, “Numerical” data are inputs that can be represented by a number, like MAP, crank angle, torque, etc. Categorical inputs generally cannot be represented by a number, but rather, describe a property such as the status of the previous, current, and next cylinders respectively.

TABLE 1

| Input Name | Number of Inputs | Input Type |
|---|---|---|
| Crank Accel, intake stroke | 6 | Numerical |
| Crank Accel, compression stroke | 6 | Numerical |
| Crank Accel, expansion stroke | 6 | Numerical |
| MAP, intake stroke | 6 | Numerical |
| MAF | 1 | Numerical |
| Requested Torque | 1 | Numerical |
| Intake Cam phase | 1 | Numerical |
| Exhaust Cam phase | 1 | Numerical |
| Engine Speed | 1 | Numerical |
| Previous Cylinder Status | 2 | Categorical |
| Current Cylinder Status | 2 | Categorical |
| Next Cylinder Status | 2 | Categorical |
| Bias Term | 1 | Constant |
| Total | 36 | |

It is noted that the “2” inputs for the status of the Previous, Current, and Next cylinder are derived from the two-encoded bits noted above. Also, Table 1 as shown is merely exemplary and should not be construed as limiting in any regard. For instance, other inputs may be used such as the firing fraction, and the High fire and/or Low fire firing pattern, sometimes referred to as the High-fire Fraction or the fraction among the total number of firing events (either High-fire or Low fire) that are High-fire

The data entered in Table 1 was collected on an eddy-current dynamometer running a production 2.0 liter, 4-cylinder engine with prototype mDSF cylinder head. A variety of engine loads, engine speeds, and firing patterns were used. Additionally, about 1.5% of the cylinder-events were deliberately given the wrong command for the Power intake valve operation, so that the network could be trained with fault data. The faults changed High fires to Low fires and vice versa, so that in these cases the air charge was incorrect, and the injected fuel was a mismatched for the incorrect air charge. No faults were performed on skips for engine safety.

To enhance machine learning to better identify faulted cylinder-events, the training set was augmented by replicating the faulted data by a factor of 10. The faults in the test data set were unchanged. The resulting number of data samples is shown in Table. The number of unique faulted events in the training data is 1183. For reference, the number of cylinder events used in training represents less than an hour of engine run time.

TABLE 2

| | Total | Fault Free | Faulted | |
|---|---|---|---|---|
| | cylinder | cylinder | cylinder | Fault |
| | events | events | events | Rate |
| Collected | 87923 | 86444 | 1479 | 1.68% |
| Training | 69155 + 1183 = 70338 | 69155 | 1183 | 1183/70338 = 1.68% |
| Test | 17585 | 17289 | 296 | 1.68% |

It is noted that the inputs listed in Table 1 and Table 2 and the specific data collection methodology and results as described herein are merely exemplary. In alternative embodiments, different inputs, or sets of inputs, and different collection methods, may be used. Similarly, specific numerical data provided herein is also exemplary and should not be construed as limiting in any regard. Such data will vary for different ICEs, collection methods, a different set of inputs, and other circumstances, etc.

In yet other alternative embodiments, the machine learning algorithm used by the classifier can be programmed or otherwise configured to make decisions to either use or not use any of the inputs listed in Table 1. With such embodiments, the machine learning algorithm can decide for itself how to use each input, or ignore it, for best results. In such embodiments, the training algorithm determines the best weights to use, and if these weights are zero or very small for an input, the resulting network will essentially ignore that input without any engineering intervention required.

### Fault Detection

In experimental embodiments, different dense neural networks, each including two hidden layers, were defined. The number of nodes per hidden layer for the different dense neural networks ranged from 5 to 25. The inputs provided to the experimental dense neural network were the same as those listed above. Since the desire was for low computational complexity, a Rectifying Linear Unit (ReLU) activation function implemented by each node of the two hidden layers, characterized by the equation f(x)=max(x,0), was used. ReLU functions are non-linear functions that generate a zero (0) output if the input is less than zero, or the input when the input is larger than zero.

In these experiments, different combinations of the number of nodes included in the two hidden layers was varied to each include 5, 10, 15, 20 and 25 nodes respectively. Table 3 and Table 4, provided below, show the results of these experiments using the different combinations of nodes included in each of the two layers and the number of detected faults.

Specifically, Table 3 shows the number of false negatives (faults that are called non-faults) for 5, 10, 15, 20 and 25 nodes in the first layer (vertical column) with 5, 10, 15, 20 and 25 nodes in the second layer (horizontal row) respectively. For example, with 10 nodes in the first layer, 0, 2, 1, 3 and 0 false negatives were detected for second layers having 5, 10, 15, 20 and 25 nodes respectively.

TABLE 3

| First | Second Layer | | | | |
|---|---|---|---|---|---|
| Layer | 5 | 10 | 15 | 20 | 25 |
| 5 | 2 | 0 | 1 | 2 | 1 |
| 10 | 0 | 2 | 1 | 3 | 0 |
| 15 | 4 | 4 | 3 | 0 | 1 |
| 20 | 4 | 2 | 2 | 0 | 1 |
| 25 | 1 | 4 | 2 | 0 | 1 |

The number of false positives (non-faults that are called faults) is provided in Table 4. Again, the number of nodes for each experiment included in the first hidden layer is provided along the vertical column, while the number of nodes in the second hidden layer is provided along the horizontal rows.

TABLE 4

| First | Second Layer | | | | |
|---|---|---|---|---|---|
| Layer | 5 | 10 | 15 | 20 | 25 |
| 5 | 10 | 8 | 3 | 6 | 3 |
| 10 | 13 | 2 | 2 | 7 | 4 |
| 15 | 4 | 5 | 8 | 4 | 19 |
| 20 | 6 | 5 | 8 | 7 | 4 |
| 25 | 5 | 4 | 2 | 9 | 4 |

As the results depicted in Table 3 and Table 4 demonstrate, the accuracy of detecting faults is 99% or better, and the accuracy of detecting non-faults (or not giving a false alarm) is more than 99%.

The computational complexity of the different neural networks can be compared by calculating the number of Multiply and Accumulate (MAC) operations per cylinder-event. With the different neural networks, each input node weights its input. Each of the hidden layers receives the outputs from all the nodes in the previous layer (or for the first hidden layer, each input.) using the ReLU activation function as described above. The output of the output layer is typically a sigmoid function (i.e., a cumulative distribution function with a value that ranges between 0 and 1), but it need not be calculated: it is monotonic, so the classification can be done based on its input.

With the above-described experiments, the number of MAC operations can be readily determined based on a combination of the number of inputs and the number of nodes used in the first and second hidden layers respectively. Using Table 1 as an example, there are a total of 36 inputs, including 29 that are numerical, 6 that are categorical and 1 that is constant (i.e., the bias term). The 29 numerical inputs are typically normalized so that their values are zero mean and have a standard deviation of one (1). The six inputs for cylinder status are binary and are typically not normalized.

Table 5 shows the number of MAC operations needed to generate a probability output with different combinations of the number of nodes used in the first hidden layer and the second hidden layer respectively. For example, with 20 nodes used in the first hidden layer (vertical column), 860, 970, 1080, 1190 and 1300 MAC operations are performed to generate a prediction output with 5, 10, 15, 20 and 25 nodes in the second hidden layer respectively.

TABLE 5

| First | Second Layer | | | | |
|---|---|---|---|---|---|
| Layer | 5 | 10 | 15 | 20 | 25 |
| 5 | 245 | 280 | 315 | 350 | 385 |
| 10 | 450 | 510 | 570 | 630 | 690 |
| 15 | 655 | 740 | 825 | 910 | 995 |
| 20 | 860 | 970 | 1080 | 1190 | 1300 |
| 25 | 1065 | 1200 | 1335 | 1470 | 1605 |

In a non-exclusive embodiment, while the output of the network is a fault/no-fault indicator for each cylinder-event, these outputs are further aggregated over time to reduce false alarms and increase confidence in a decision. For example, the number of faults on a cylinder may be summed over 1024 cycles and compared to a threshold. Only if the threshold is exceeded will a fault be declared. Because of this step, the accuracy of detecting faults and no-faults need not be perfect: an accuracy of about 95% is usually adequate for a good detector.

### Binary Logistics Regression for Fault Detection

The above-described machine learning algorithms relying on relatively small multi-layer neural network classifier demonstrate a high success rate at predicting faults (i.e., identifying cylinder-events where the Power intake valve does not activate or deactivate as commanded.)

In an alternative embodiment, a simplified neural network that has only input nodes and a single output node, but no hidden layer(s), may also be used for generating a single binary value output (i.e., either a fault or no fault). Such a simplified neural network is sometimes referred to as a binary Logistic Regression (“binary LR”) type classifier.

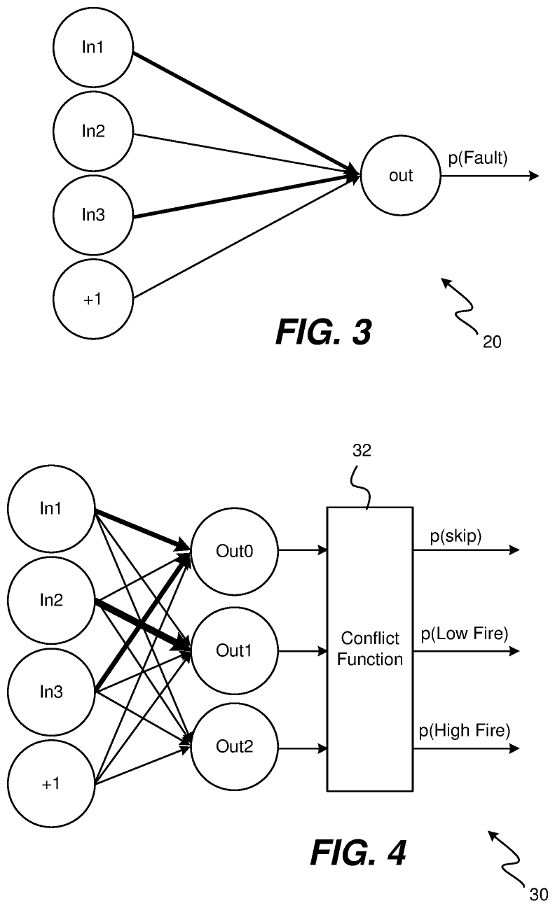

Referring to FIG. 3, an exemplary binary Logistic Regression classifier 20 is illustrated. As evident in the figure, the classifier 20 includes a plurality of inputs (In1, In2 and In3 and a bias term (+1)) and an output node. Each of the inputs In1, In2 and In3 and the bias term (+1) are weighted with respect to another, as represented by the thickness of the arrows into the output node. The output node implements binary Logistic Regression machine learning algorithm. The output node generates a binary output of either a fault or no fault in response to the to the weighted inputs respectively.

It is noted for the sake of simplicity, only three inputs are shown. In other embodiments, any number of inputs may be used with a binary Logistic Regression type classifier.

The binary Logistic Regression machine learning algorithm essentially trains the output node to create a dividing “line”, or a “hyperplane”, in the input space. Whenever a set of inputs has a positive weighted sum (i.e., above the dividing line or hyperplane) the output node generates an output of a first binary value, while any set of inputs having a negative weighted sum (i.e., below the dividing line or hyperplane) is given a second complementary binary value. For example, a positively weighted sum of inputs is given a “no-fault” status, whereas a negatively weighted sum of inputs is given a “fault” status. Alternatively, the complement of the above may be used, meaning positive and negative weighted sums are given “fault” and “no-fault” status respectively.

In various embodiments, the dividing “line”, or a “hyperplane” may be equated with a 50% probability. When the weighted sum of a given set of inputs is above or below the 50% probability, the output will be the first binary value or the second binary value respectively. It should be noted that the probability need not be fixed at 50%. In various embodiments, the probability line can widely vary, but regardless of the percentage, the first binary value and the second binary value are typically flagged depending on if a sum of weighted values are above or below the threshold, whatever it happens to be.

Table 6 below provides a summary of test results derived from using binary Logistic Regression machine learning algorithm. Out of 17,585 total High or Low fire events, a total of 296 were intentional faults. Of the 17,289 High or Low fire events that were not faults, the binary Logistic Regression machine learning algorithm identified 736 as faults. Among the 296-cylinder events that were deliberate faults, the binary Logistic Regression machine learning algorithm identified 196 of them as non-faults.

TABLE 6

| | non- | |
|---|---|---|
| Binary LR | Faults | Faults |
| Total events | 17289 | 296 |
| Error events | 736 | 196 |

One advantage of using a binary Logistic Regression classifier is simplicity in implementation and that this type of classifier works relatively well with inputs that can be linearly separated and readily classified into either one of two groups.

### Multi-Class Logistic Regression

A multi-class Logistic Regression classifier may be used for improved fault detection accuracy. Multiclass Logistic Regression uses multiple binary Logistic Regressions in parallel, one for each predicted class. The output for per class is the probability that the specified class either occurred or did not occur. Since there is a possibility that different classes may predict opposing probabilities, the outputs of each class can be normalized and then the class with the Highest probability is selected for as final prediction outcome.

A multi-class Logistic Regression classifier is suitable for predicting if a cylinder-event of an ICE is (a) a skip, (b) a Low fire, or (c) a High fire respectively.

Referring to FIG. 4, an exemplary multi-class binary Logistic Regression classifier 30 is illustrated. The classifier 30 includes a plurality of input nodes (In1, In2, In3 and a bias term (+1)), three output nodes (Out0, Out1 and Out2), and a “Conflict” function 32. Again, the number of input nodes shown is relatively small for the sake of simplicity. In actual embodiments, the number of inputs may widely vary to fewer to significantly more than three.

Each of the outputs Out0, Out1 and Out2 receive weighted inputs from each of the input nodes In1, In2, In3 and a bias term (+1) for each cylinder event. Each output node generates a different binary output using a different activation function

$$S ( {\sum }_{k = 1}^{4} {w}_{1 k} {x}_{k} )$$

Specifically, the output nodes Out0, Out1 and Out2 generate binary predictions for skip “p(skip)”, a Low fire “p(Low fire)”, and a High fire “p(High fire)” for each cylinder event respectively. The Conflict function 32 resolves any conflicts between the outputs (e.g., if both a skip and a fire are predicted) by normalizing the outputs for the different classes and then picking the Highest probability output among the normalized outputs. For example, if the normalized probabilities for a skip and a Low fire are 70% and 55% respectively, then the Conflict function 32 selects the skip probability as the final prediction outcome, while treating the Low fire probability as false.

### Computational Requirements

The computational requirement for multiclass versus binary Logistic Regression classification is larger because each classification class has its own output node, each receiving a set of weighted inputs. In an exemplary implementation of the multi-class binary Logistic Regression classifier 30, each of the output nodes out0, Out1 and Out2 for the three classes (skip, Low fire, High fire) each receive 33 plus a bias term or 34 weighted inputs. In this example, the number of categorical inputs is 4 instead of 6 because the 2 current cylinder status inputs are not used because the cylinder status is predicted by the classifier, and faults are flagged when the prediction does not match what was commanded. As a result, there are a total of 34 inputs, including 29 numerical, 4 categorical, and 1 bias terms (29+4+1=34). In alternative embodiments, the 29 numerical inputs may or may not be normalized.

Therefore, with three outputs, the classifier 30 generates a predictive outcome by performing (3×34)+29=131 MAC operations per cylinder event, assuming 29 MAC operations for normalization. However, if the normalization operation is combined with the weighting at the input nodes, then the 29 MAC operations can be eliminated, meaning the computational load can be reduced to 102 MAC operations.

### Multi-Class Logistic Regression Test Results

In an actual test run, the input data provided in Table 1 was provided to the multi-class Logic Regression classifier 30. In this experiment, the current cylinder status was not inputted to the classifier 30, but instead was compared to the output to determine if a fault was detected. The test results for this test are provided in Table 7 and Table 8.

Table 7 includes three rows where “0”, “1” and “2” signify skips, Low fires and High fires respectively. The three columns, from left to right, signify the number of predicted skips, Low fires and High fires respectively. In this example:

(a) Row 0 indicates that there were 7017 skips, and all were correctly predicted.

(b) Row 1 indicates that 4405 Low fires were correctly predicted, while 16 Low fires were incorrectly predicted as High fires.

(c) Row 2 indicates that 6136 High fires were correctly predicted, while 11 High fired were incorrectly predicted as Low fires.

TABLE 7

| | Skips | Low Fire | High Fire |
|---|---|---|---|
| 0 | 7017 | 0 | 0 |
| 1 | 0 | 4405 | 16 |
| 2 | 0 | 11 | 6136 |
| | 0 | 1 | 2 |

In this example, there were a total of 17,585-cylinder events. Of these, 17,558 were correctly predicted and 27 were incorrectly predicted. With 27 errors among 17,585-cylinder events, the accuracy of the multi-class Logic Regression classifier 30 in this test was approximately 99.8%.

The results are summarized in Table 8. Of the 27 errors, 24 were false positives (e.g., a fault being declared when no fault occurred) and 3 were false negatives (e.g., a fault not being detected).

TABLE 8

| | Non- | | | false | false |
|---|---|---|---|---|---|
| Events | fault | fault | errors | positive | negative |
| 17585 | 17289 | 296 | 27 | 24 | 3 |

### Real Time Fault Detection

As noted above, a mDSF controlled ICE has additional fault detection requirements due to the separate operation of the Power intake valve from the other three valves (the Miller intake valve, plus two exhaust valves). Also, the large number of firing patterns available on a mDSF controlled ICE make it very challenging to discern patterns indicative of a Power intake valve fault. However, as described herein, such faults can be detected using machine learning classifiers, such as but not limited to multi-layer (e.g., Perceptron or “MLPs”), multiclass Logistic Regression, and/or binary Logistic Regression classifiers as described herein.

By first training such classifiers using machine learning and then installing such trained classifiers within or in cooperation with a mDSF engine controller, real-time predictions can be made for (1) Power intake valve faults and non-faults and/or (2) whether each cylinder event is a skip, a Low fire or a High fire.

As described herein, certain classifiers as noted herein have a ninety-nine percent (99%) degree of accuracy for detecting faults and non-faults. In addition, such classifiers use only a moderate amount of data and limited computational resources.

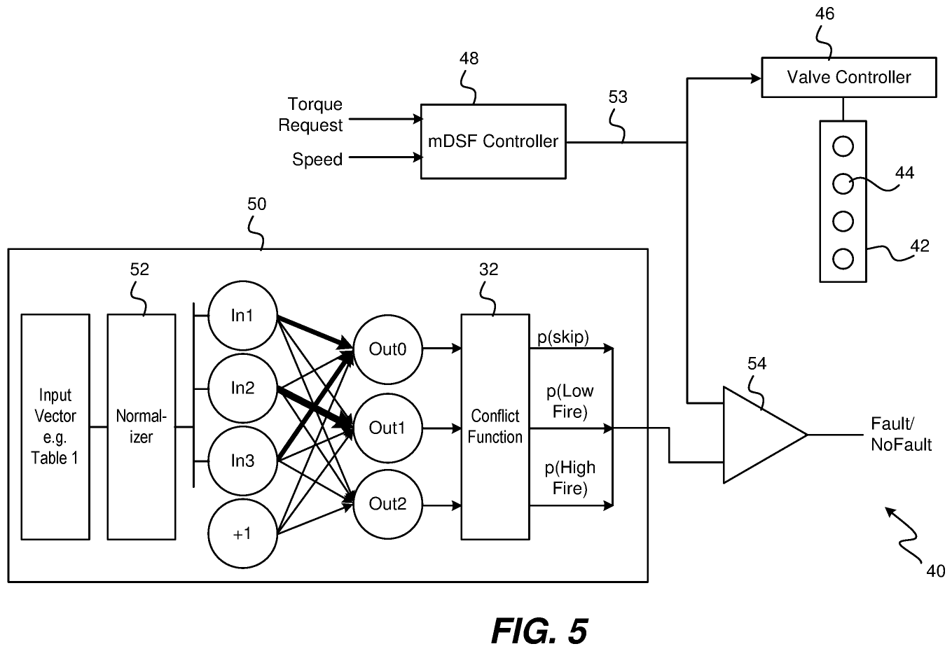

Referring to FIG. 5, an exemplary mDSF engine system 40 is illustrated. The engine system 40 includes an ICE 42 with multiple cylinders 44, a valve controller 46, and mDSF controller 48, a machine learning based classifier 50 including a normalizer 52, and a fault detector 54.

In various embodiments, the ICE 42 may have four cylinders 44 as shown or any other numbers of cylinders such as 2, 3, 5, 6, 8, 10, 12, 16, etc. In addition, the ICE 42 may be spark-ignition or compression-ignition. Also, the ICE 44 may be able to combust one or more different types of fuels, such as gasoline, ethanol, diesel, compressed natural gas, methanol, or any combination thereof. In yet other embodiments, the ICE 42 may operate in cooperation with a turbo system, a supercharger system, and/or an Exhaust Gas recirculation (EGR) system as is well known in the art, none of which are illustrated for the sake of simplicity.

The mDSF controller 48 is arranged to receive input(s) including a torque request and optionally a speed signal indicative of the speed of the ICE 42. In response, the mDSF controller determines a firing fraction, including High and Low firing patterns, for operating the ICE 42 so that the torque output of the ICE 42 meets the torque request.

Once the firing fraction and the High and Low firing pattern are defined, the mDSF controller is responsible for providing valve commands 53, on a cylinder event-by-cylinder event basis, to the valve controller 46. Such valve commands may include:

1. A skip command, in which case the Miller, Power intake valves and exhaust valves are deactivated for a given cylinder event;

2. A Low fire, in which case the Miller intake valve and exhaust valves are activated, but the Power intake valve is deactivated for the given cylinder event; and

3. A High fire, in which case both the Miller and Power intake valves are activated as well as the exhaust valves for the given cylinder event.

In response to the valve commands 53, the valve controller 46 (e.g., OCVs) controls the individual valves of the cylinders 44 to open or close so that skips, Low fires and High fires are implemented as commanded on a cylinder event-by-cylinder event basis.

The classifier 50, in this non-exclusive embodiment, is a multiclass Logistic Regression classifier that includes input nodes In1, In2 and In3 and a (+1) bias term, three output nodes Out0, Out1 and Out2, and a Conflict function 32. Each of the output nodes Out0, Out1 and Out2 uses a different activation function for generating individual binary predictions for the classes including p(skip), p(Low fire), and p(High fire) respectively. The Conflict function 32 resolves any conflicts between the output classes by picking the Highest probability among the three prediction classes as the final predicted outcome.

During operation, the normalizer 52 receives an input vector on a cylinder event-by-cylinder event basis. In a non-exclusive embodiment, the input vector can include the parameters listed in Table 1 herein. In other embodiments, an input vector that includes a different set of parameters may be used. The normalizer 52 is responsible for scaling within a predefined range (e.g., between 0 and 1) so that the individual parameters of the vector can be properly compared to one another.

The input nodes In1, In2 and In3 each weigh the normalized parameters of the input vector. The input nodes In1, In2 and In3 provide the weighted values to each of the output nodes Out0, Out1 and Out2 respectively. In response, the Out0, Out1 and Out2 generate binary predictions for its assigned class. That is, Out0 predicts a skip (e.g., either skip or no skip), Out1 predicts a Low fire (e.g., either Low fire or not), and Out2 predicts a High fire (e.g., either a High fire or not) for a given cylinder event based on the input vector.

The Conflict function 32 is provided to resolve conflicts among the three class predictions. Ideally, only one of the predictions is above the dividing “line”, “hyperplane”, or probability threshold for each cylinder event output. In which case, there is no conflicts and the one prediction above the line, hyperplane and/or threshold is selected as the predicted class output of the classifier 50. On the other hand, if two (or more) of the predicted classes are above the line, hyperplane and/or threshold, then the conflict function 32 resolves the conflict by selecting the prediction having the highest probability. For example, if a Low fire has a probability of 52% and a High fire a probability of 78%, then the conflict is resolved by selecting the latter as the final output prediction of the classifier for the given cylinder event.

The classifier 50 thus generates a series of skip/Low Fire/High fire predictions on a cylinder event-by-cylinder event basis. With each input vector, the classifier 50 generates a classification prediction that the corresponding cylinder event was either a skip, a Low fire, or a High fire respectively

The fault detector 54 compares the classification prediction from the classifier 50 with the actual command 53 generated by the mDSF controller 48 for each cylinder event. If the classification prediction and the actual command the same, then no fault flag is generated. If the two inputs are different, the fault detector 54 generates a fault flag.

Table 9 is a tabulation of test results collected during real-time operation of the multi-class Logistic Regression algorithm similar to that illustrated in FIG. 5. In this example, data was collected in less than one hour of operation of the ICE 42 and over 18902 cylinder-events were classified. The results of this testing indicate, as depicted in Table 9, a total of five false negatives (actual faults thought to be valid) and twelve false positives. This test data demonstrates that overall accuracy of detecting faults is over 99.7% and the accuracy for detecting false positives is above 99.9%.

TABLE 9

| Engine | | | | | | |
|---|---|---|---|---|---|---|
| Speed, | NMEP, | | | Induced | Actual | Predicted |
| RPM | bar | FF | HF | Fault? | Fire | Fire |
| 1500 | 6 | 2/5 | 1/2 | No | High | Low |
| 1500 | 6 | 2/5 | 1/2 | Yes | High | Low |
| 1500 | 6 | 2/5 | 1/2 | Yes | High | Low |
| 1900 | 3.5 | 3/5 | 1/4 | No | Low | High |
| 2100 | 4 | 1 | 1 | No | High | Low |
| 2400 | 2.5 | 2/3 | 1 | Yes | Low | Skip |
| 2400 | 2.5 | 2/3 | 1 | No | High | Low |
| 2400 | 2.5 | 2/3 | 1 | No | High | Low |
| 2400 | 2.5 | 2/3 | 1 | No | High | Low |
| 2400 | 2.5 | 2/3 | 1 | No | High | Low |
| 2400 | 2.5 | 2/3 | 1 | No | High | Low |
| 2400 | 2.5 | 2/3 | 1 | No | High | Low |
| 2400 | 2.5 | 2/3 | 1 | No | High | Low |
| 2400 | 2.5 | 2/3 | 1 | No | High | Low |
| 2400 | 2.5 | 2/3 | 1 | No | High | Low |
| 2400 | 4.5 | 1/2 | 2/5 | Yes | High | Low |
| 2450 | 6.5 | 1/2 | 1/3 | Yes | High | Low |

### Advantages of Logistic Regression

Logistic Regression, both binary and multi-class, offers several advantages. First, Logistic Regression is highly accurate, routinely achieving valve fault detection accuracy of at least 95%, and more likely 99% or higher. Second, the number of MAC operations needed for implementing Logistic Regression are relatively low. Third, hardware and software resources needed for Logistic Regression are minimal and are relatively straight forward to implement. With both binary and multi-class Logistic Regression, the inputs of an input vector are weighted and then directly applied to the output node or nodes. In response, the output node or nodes make prediction(s) by comparing the weighted set of inputs to threshold(s) respectively. Logistic Regression classifiers can, therefore, be readily deployed in real-world applications, such as on vehicles having mDSF controlled ICEs.

### Alternative Embodiments

One of the features of a mDSF controlled ICE is that each cylinder can have three operational states. A multiclass Logistic Regression classifier can be used to identify the actual state of the cylinder and compare it to the expected state. If only determining whether the Power intake valve is operating correctly, skipping events can be ignored and predictions can be limited to whether the cylinder operated in a High fire mode or a Low fire mode. This result can then be compared to the commanded operation (the current cylinder status), and a fault declared if the two are different. Such an operation requires the calculation of only one linearly weighted sum. Further, the normalization step can be combined with the corresponding weight after training is complete, further reducing the computation load.

With both the binary and multi-class Logistic Regression classifier embodiments, the weighted sum of the inputs of an input vector are directly compared to threshold by the output node, typically without any intermediate hidden layer nodes. Such embodiments provide very high levels of accuracy. Since these embodiments consume minimal computational resources, a plurality of binary and/or multi-class Logistic Regression classifiers can be practically used. For example, one classifier can be used with one set of inputs weighted for predicting Low fires, while another classifier can be used with the same or different set of inputs weighed for predicting High fires. In yet other embodiments, one or more classifiers can be replicated and each optimized for different operating conditions. Such optimizations may include, but are by no means limited to, cold starts of the ICE, low RPM and/or low load conditions, etc. In each case, the weights for the individual inputs of the input vector, and the predictive algorithm (e.g., activation and/or ReLU function) can be determined and trained using machine learning.

In yet other embodiments, one or more multilayer classifiers can also be employed, each using weighted inputs optimized for a particular type of cylinder event (e.g., predicting skips, High fires, or Low fires) or for a particular application (e.g., cold starts, low RPM and/or low load conditions, etc.).

The above-described classifiers, regardless of the embodiment, all share a common characteristic in that all generate a predictive outcome based on a weighted sum of inputs that is then compared to a threshold value. In each case, the output node generates a predictive output either directly from a set of weighted inputs as described above with regard to binary and multi-class Logistic Regression classifiers, or indirectly via the nodes of one or more hidden layers as is the case with multi-level perceptrons. With each embodiment, the various nodes, including input, output and any nodes of intermediate hidden layer(s), may optionally be trained using machine learning.

It is also noted that while the present invention was described in the context of a mDSF controlled ICE, this is by no means a limitation. On the contrary, the machine learning based classifiers as described herein may be used for any ICE wherein the output of cylinders is modulated to be one of several level outputs. Such ICEs may include any variable displacement engine, including but not limited to engines that are controlled using skip fire, dynamic skip fire, or variable displacement were cylinders are selectively deactivated using one or more non-rotating patterns, or engines where all cylinders are fired without skips, but the output of the fires are modulated to have multiple levels.

Although only a few embodiments have been described in detail, it should be appreciated that the present application may be implemented in many other forms without departing from the spirit or scope of the disclosure provided herein. Therefore, the present embodiments should be considered illustrative and not restrictive and is not to be limited to the details given herein but may be modified within the scope and equivalents of the appended claims.

What is claimed is:

1. An engine valve actuation fault detector configured to identify engine valve actuation faults during engine operation where cylinder events are commanded to either skip or fire at one of multiple levels, the engine valve fault detector including a classifier having an input layer and an output layer.

2. The engine valve actuation fault detector of claim 1, further comprising a fault/no fault indicator that indicates whether a valve fault has occurred or not during a selected cylinder event.

3. The engine valve actuation fault detector of claim 2, wherein the fault/no fault indicator operates by comparing for the select cylinder event:
(a) a predicted valve behavior as predicted by the classifier; and
(b) a command for the select cylinder event,
wherein the fault is indicated as having occurred during the select cylinder event when (a) does not match proper valve behavior for implementing the command during the select cylinder event.

4. The engine valve actuation fault detector of claim 3, wherein the command for the cylinder event is selected among the following:
a skip;
a Low fire; or
a High fire.

5. The engine valve actuation fault detector of claim 1, wherein the classifier is a multi-class Logistic Regression classifier.

6. The engine valve actuation fault detector of claim 5, wherein the multi-classes include two or more of the following cylinder operations:
(a) a skip;
(b) a Low fire; or
(c) a High fire.

7. The engine valve actuation fault detector of claim 5, wherein the multi-class Logistic Regression classifier includes a plurality of input nodes in the input layer.

8. The engine valve actuation fault detector of claim 7, wherein the plurality of input nodes is configured to weigh one or more parameters of an input vector or receive the one or more parameters already weighted.

9. The engine valve actuation fault detector of claim 7, further comprising a normalizer for normalizing parameters either (a) of an input vector provided to the input layer or (b) provided to the output layer from a previous layer of the classifier.

10. The engine valve actuation fault detector of claim 5, wherein the multi-class Logistic Regression classifier includes a multiplicity of output nodes configured to implement activation functions for generating a multiplicity of multi-class predictions respectively.

11. The engine valve actuation fault detector of claim 10, further comprising a conflict function for selecting a highest probability class among conflicts between the multi-class predictions.

12. The engine valve actuation fault detector of claim 1, wherein the classifier is a multi-layer perceptron classifier (MLP) including the input layer, the output layer, and one or more hidden layers between the input layer and the output layer.

13. The engine valve actuation fault detector of claim 12, wherein the input layer includes a plurality of input nodes, the plurality of input nodes configured to weigh a plurality of input parameters of an input vector.

14. The engine valve actuation fault detector of claim 12, wherein the one or more hidden layers include one or more nodes configured to implement activations functions on inputs received from a previous layer.

15. The engine valve actuation fault detector of claim 12, wherein the output layer is configured to generate outputs that identify engine valve actuation faults by performing an activation function on inputs received from a previous hidden layer of the classifier.

16. The engine valve actuation fault detector of claim 1, wherein the classifier is a binary Logistic Regression classifier configured to generate a binary output from an input vector received by the input layer.

17. The engine valve actuation fault detector of claim 1, wherein the classifier further comprises a neural network provided between the input layer and the output layer, the neural network including a plurality of nodes arranged in one or more hidden layers, the one or more nodes configured to cooperatively operate to identify the engine valve actuation faults from input vectors provided to the input layer of the classifier respectively.

18. The engine valve actuation fault detector of claim 17, wherein the plurality of nodes arranged in the one or more hidden layers are trained using machine learning.

19. The engine valve actuation fault detector of claim 1, wherein the valve actuation faults include:
a failure of a given valve to actuate and open; and
a failure of the given valve to deactivate and remain closed.

20. The engine valve actuation fault detector of claim 1, wherein inputs to the classifier include:
a commanded firing state of a current cylinder event;
a commanded firing state of a previous cylinder event that immediately precedes the current cylinder event in an engine firing order; and
a commanded firing state of a following cylinder event that immediately follows the current cylinder event in the engine firing order.

21. The engine valve fault detector of claim 1, wherein the input layer is configured to receive an input vector of parameters, the including one or more of the following:
crank acceleration during an intake stroke;
crank acceleration during a compression stroke;
crank acceleration during an expansion stroke;
Manifold Absolute Pressure (MAP)
Mass Air flow (MAF);
requested torque;
intake cam phase;
exhaust cam phase;
engine speed;
previous cylinder status;
current cylinder status;
next cylinder status;
firing fraction; and
High and/or Low firing pattern.

22. The engine valve actuation fault detector of claim 1, wherein inputs to the input layer of the classifier include:
one or more measures of crankshaft acceleration taken during an intake stroke associated with the current cylinder event;
one or more measures of crankshaft acceleration taken during a compression stroke associated with the current cylinder event; and
one or more measures of crankshaft acceleration during an expansion stroke associated with the current cylinder event.

23. The engine valve actuation fault detector of claim 1, wherein inputs to the input layer of the classifier further comprise a bias term.

24. A valve fault classifier, comprising:
an output node configured to generate a valve fault prediction for a valve during a cylinder event by comparing a sum of weighed inputs of an input vector associated with the cylinder event to a threshold,
wherein the sum of weighed inputs of the input vector are directly received by the output node from one or more input nodes,
wherein the valve fault prediction for the cylinder event is either a valve fault or no valve fault.

25. The valve fault classifier of claim 24, wherein directly received means no multiply-accumulate (MAC) operations are performed on the sum of weighed inputs of the input vector by any hidden layer nodes between the one or more input nodes and the output node.

26. The valve fault classifier of claim 24, wherein the valve fault indicates that the valve failed to open when commanded to activate.

27. The valve fault classifier of claim 24, wherein the valve fault indicates that the valve opened when commanded to deactivate.

28. The valve fault classifier of claim 24, wherein the valve is a Power intake valve.

29. The Logistic Regression classifier of claim 24 wherein the valve fault prediction indicates if the cylinder successfully or unsuccessfully implemented a High fire output as commanded during the cylinder event.

30. The valve fault classifier of claim 24, wherein the valve fault prediction indicates if the cylinder successfully or unsuccessfully implemented a Low fire output as commanded during the cylinder event.

31. The valve fault classifier of claim 24, wherein the valve fault prediction indicates if the cylinder successfully or unsuccessfully implemented one of multiple level torque outputs as commanded during the cylinder event.

32. The valve fault classifier of claim 24, wherein the valve fault classifier is a binary Logistic Regression classifier including only the output node.

33. The valve fault classifier of claim 24, wherein the valve fault classifier is a multi-class Logistic Regression classifier and includes multiple output nodes including the output node.

34. The valve fault classifier of claim 31, wherein:
the multiple output nodes are each configured to receive the sum of weighted inputs of the input vector directly from the one or more input nodes; and
the multiple output nodes are configured to generate multiple predictions including the valve fault prediction.

35. The valve fault classifier of claim 33, wherein the multiple predictions include, beside the valve fault prediction, one or more of the following:
(a) the cylinder skipped during the cylinder event;
(b) the cylinder generated a Low fire output during the cylinder event; or
(c) the cylinder generated a High fire output during the cylinder event.

36. The valve fault classifier of claim 34, further comprising a conflict function capable of selecting one of the multiple predictions when two or more of the multiple predictions are in conflict.

37. The valve fault classifier of claim 24, wherein at least some of the weighted inputs among the sum of inputs of the input vector are normalized.

38. The valve fault classifier of claim 24, wherein the sum of inputs of the input vector include one or more of the following:
crank acceleration during an intake stroke;
crank acceleration during a compression stroke;
crank acceleration during an expansion stroke;
Manifold Absolute Pressure (MAP)
Mass Air flow (MAF);
requested torque;
intake cam phase;
exhaust cam phase;
engine speed;
previous cylinder status;
current cylinder status;
next cylinder status;
firing fraction; and
High and/or Low firing pattern.

39. The valve fault classifier of claim 24, wherein the weighed inputs of an input vector are varied for each of multiple operational states, the multiple operational states including at least two of:
idle;
cold start;
warm; and
Deceleration Cylinder Cut-Off (DCCO).

40. The valve fault classifier of claim 24, further configured to operate in cooperation with a comparator that compares the valve fault prediction with an actual valve command, the comparator further configured to generate a fault flag when the valve fault prediction and the actual valve command differ.

41. A classifier, comprising:
a plurality of input nodes each arranged to receive an input vector associated with a cylinder event of an engine where cylinders can be selectively commanded to skip during some cylinder events or fire during other cylinder events; and
an output node configured to generate a valve no-fault/fault prediction for the cylinder event by comparing a received weighted sum of inputs from the input vector associated with the cylinder event to a threshold;
wherein the valve no-fault/fault prediction for the cylinder event is indicative that a valve of the cylinder either did or did not properly activate or deactivate as commanded during the cylinder event as required for the cylinder to properly skip or fire as commanded.

42. The classifier of claim 41, wherein the classifier is a Logistic Regression classifier and the output node receives the weighted sum of inputs directly from the plurality of input nodes and no multiply-accumulate (MAC) operations are performed on the sum of weighed inputs by any hidden layer nodes between the plurality of input nodes and the output node.

43. The classifier of claim 42, wherein the Logistic Regression classifier is a binary Logistic Regression classifier having only the output node.

44. The classifier of claim 42, wherein the Logistic Regression classifier is a multi-class Logistic Regression classifier having multiple output nodes including the output node, wherein the multi-class output nodes generate predictions for two or more of the following:
(i) the cylinder skipped during the cylinder event;
(ii) the cylinder fired during the cylinder event;
(iii) the cylinder generated a High torque output during the cylinder event; or
(iv) the cylinder generated a Low torque output during the cylinder event.

45. The classifier of claim 41, wherein the classifier is a perceptron classifier having hidden layer nodes arranged in one or more hidden layers between the plurality of input nodes and the output node, the hidden layer nodes performing multiply-accumulate (MAC) operations on the input vector before receipt by the output node.

46. The classifier of claim 41, wherein the valve of the cylinder is a Power intake valve, and the no-fault/fault prediction indicates if the Power intake valve either properly or improperly activated when the cylinder is commanded to be fired and generate a High torque output during the cylinder event.

47. The classifier of claim 41, wherein the valve of the cylinder is a Power intake valve, and the no-fault/fault prediction indicates if the Power intake valve either properly or improperly deactivated when the cylinder is commanded to be fired and generate a Low torque output during the cylinder event.

48. The classifier of claim 41, wherein the valve of the cylinder is a Power intake valve, and the no-fault/fault prediction indicates if the Power intake valve either properly or improperly deactivated when the cylinder is commanded to be skipped during the cylinder event.

49. The classifier of claim 41, wherein machine learning is used to train the classifier to make the no-fault/fault prediction from the weighted sum of inputs.

50. The classifier of claim 41, wherein the no-fault/fault prediction is a probability that is compared to the threshold, an outcome of the no-fault/fault prediction determined if the probability is above or below the threshold.

51. The classifier of claim 41, wherein at least some of the inputs of the input vector are normalized.

52. The classifier of claim 41, wherein the inputs of the input vector include one or more of the following:
crank acceleration during a compression stroke;
crank acceleration during an expansion stroke;
Manifold Absolute Pressure (MAP)
Mass Air flow (MAF);
requested torque;
intake cam phase;
exhaust cam phase;
engine speed;
previous cylinder status;
current cylinder status;
next cylinder status
firing fraction; and
High and/or Low firing pattern.

53. The classifier of claim 41, wherein the weighted sum of the inputs from the input vector are varied for each of multiple operational states, the multiple operational states including at least two of:
idle;
cold start;
warm; and
Deceleration Cylinder Cut-Off (DCCO).

54. The classifier of claim 41, further configured to operate in cooperation with an engine controller that controls the engine to selectively operate in a cylinder deactivation mode wherein a first group of one or more cylinders are continually fired and a second group of one or more cylinders are continually skipped while operating the engine at an effective reduced displacement that is less than full displacement of the engine.

55. The classifier of claim 41, further configured to operate in cooperation with an engine controller that controls the engine to selectively operate in a skip fire mode wherein at least one cylinder is fired, skipped and either fired or skipped over three successive cylinder events while operating the engine at an effective reduced displacement that is less than full displacement of the engine.

56. The classifier of claim 41, further configured to generate a plurality of valve no-fault/fault prediction for a plurality of cylinder events during operation of the engine.

57. The classifier of claim 41, further configured to operate in cooperation with a comparator that compares the valve no-fault/fault prediction with an actual valve command, the comparator further configured to generate a fault flag when the valve no-fault/fault prediction and the actual valve command differ.
